(19) United States
(12) Patent Application Publication
(10) Pub. No.: US 2014/0118731 A1
(43) Pub. Date: May 1, 2014

(54) Adaptive Front Lens for Raman Spectroscopy Free Space Optics

(71) Applicant: W. Stanley Ayers, Cary, NC (US)

(72) Inventor: W. Stanley Ayers, Cary, NC (US)

(73) Assignee: MUSTARD TREE INSTRUMENTS, LLC, Research Triangle Park (US)

(21) Appl. No.: 14/064,304

(22) Filed: Oct. 28, 2013

Related U.S. Application Data
(60) Provisional application No. 61/720,317, filed on Oct. 30, 2012.

(51) Int. Cl. G01J 3/02; G01J 3/44

(52) U.S. Cl. CPC G01J 3/0237; G01J 3/44
USPC 356/301

(57) ABSTRACT

A Raman spectroscopy system features free space optics, wherein an excitation laser beam is directed to a sample, and Raman scattered photons are collected from a desired point of the excitation beam's impact on the sample, through the air, without the use of fiber optics. The excitation laser is directed to a sample, such as fluid flowing in a pipe, through a sight glass in the pipe. A front lens assembly, having a fixed focal point at a predetermined z-axis distance in front of the front-most lens, collects Raman scattered photons, which pass through an optical system to a detector. The Collection Point (CP), or the point along the excitation beam (and within the sample) at which Raman scattered photons are collected—which coincides with the focal point of the front lens assembly—is controlled by physically translating the front lens assembly along the optical axis.

This application also claims priority to U.S. Provisional Patent Application Ser. No. 61/720,317, titled, “Adaptive Front Lens for Raman Spectroscopy Free Space Optics,” filed Oct. 30, 2012, the disclosure of which is incorporated herein by reference in its entirety.

### FIELD OF INVENTION

The present invention relates generally to optics, and in particular to an adaptive front lens for a Raman spectroscopy system featuring free space optics.

### BACKGROUND

Raman spectroscopy is an analytic instrumentation methodology useful in ascertaining and verifying the molecular structures of materials. Raman spectroscopy relies on inelastic scattering, or Raman scattering, of monochromatic light, resulting in an energy shift in a portion of the photons scattered by a sample. From the shifted energy of the Raman scattered photons, vibrational modes characteristic to a specific molecular structure can be ascertained. This is the basis of using Roman spectroscopy to ascertain the molecular makeup of a sample. In addition, by analytically assessing the relative intensity of Raman scattered photons, the purity of a sample can be determined.

Typically, a sample is illuminated with a laser beam. Light from the illuminated spot is collected by lenses and analyzed. Wavelengths close to the laser line due to elastic Rayleigh scattering are blocked or filtered out, while chosen bands of the collected light are directed onto a detector.

The Raman effect occurs when light impinges upon a molecule and interacts with the electron cloud and the bonds of that molecule. For the spontaneous Raman effect, which is a form of light scattering, a photon excites the molecule from its ground state to a virtual energy state. The energy state is referred to as virtual since it is temporary, and not a discrete (real) energy state. When the molecule relaxes, it emits a photon and it returns to a different rotational or vibrational state. The difference in energy between the original state and this new state leads to a shift in the emitted photon's frequency away from the excitation wavelength.

If the final vibrational state of the molecule is more energetic than the initial state, then the emitted photon will be shifted to a lower frequency in order for the total energy of the system to remain balanced. This shift in frequency is known as a Stokes shift. If the final vibrational state is less energetic than the initial state, then the emitted photon will be shifted to a higher frequency, which is known as an Anti-Stokes shift. Raman scattering is an example of inelastic scattering because of the energy transfer between the photons and the molecules during their interaction.

The pattern of shifted frequencies is determined by the rotational and vibrational states of the sample, which are characteristic of the molecules. The chemical makeup of a sample may thus be determined by quantitative analysis of the Raman scattering.

Conventional Raman spectroscopy relies on a complex, sensitive, carefully calibrated optical system comprising a laser providing a source beam; an array of photodetectors for detecting Stokes and anti-Stokes shifted photons; optics, including lenses, mirrors, and optical filters; and data processing systems. Conventional Raman spectroscopy systems are maintained in a controlled environment, such as a laboratory.

In some applications, real-time (or near-real time) analysis of materials is required. For example, it may be advantageous to monitor the composition and purity of a liquid or gas flowing in a pipe, such as precursor gases in semiconductor manufacturing operations, various chemicals utilized in petroleum refineries, and the like. To monitor such material flows in situ, conventional, lab-based Raman spectroscopy systems deliver an incident laser beam into a pipe via an optical fiber running from the lab to the factory floor, and inserted through the pipe wall to a desired depth. Scattered photons are collected by a second optical fiber, and returned to the spectroscopy system.

Such remote Raman spectroscopy systems exhibit numerous deficiencies. The optical fibers cause a loss in the optical intensity of both the incident laser and the Raman scattered photons. This intensity loss may be nonlinear, and otherwise difficult to compensate. Additionally, the fiber itself has a Raman signature, which may interfere with analysis of the sample. Furthermore, precise positioning of the optical fibers with in the material pipe may be difficult to control, and cannot easily be dynamically adjusted, nor can positioning of the probe be easily replicated after routine maintenance, such as removal for cleaning. This makes consistent measurements difficult.

The Background section of this document is provided to place embodiments of the present invention in technological and operational context, to assist those of skill in the art in understanding their scope and utility. Unless explicitly identified as such, no statement herein is admitted to be prior art merely by its inclusion in the Background section.

### SUMMARY

The following presents a simplified summary of the disclosure in order to provide a basic understanding to those of skill in the art. This summary is not an extensive overview of the disclosure and is not intended to identify key/critical elements of embodiments of the invention or to delineate the scope of the invention. The sole purpose of this summary is to present some concepts disclosed herein in a simplified form as a prelude to the more detailed description that is presented later.

According to one or more embodiments described and claimed herein, a Raman spectroscopy system features free space optics, wherein an excitation laser beam is directed to a sample, and Raman scattered photons are collected from a desired point of the excitation beam's impact on the sample, through the air, without the use of fiber optics. The excitation laser is directed to a sample, such as fluid flowing in a pipe, through a sight glass in the pipe. A front lens assembly, having a fixed focal point at a predetermined z-axis distance in front of the front-most lens, collects Raman scattered photons, which pass through an optical system to a detector. The excitation laser passes through the center of the front lens assembly with minimal distortion due to its compact size. This beam causes Raman scattering of all transparent or translucent material through which it passes, all along the length of the beam. The Collection Point (CP), or the point along the excitation beam (and within the sample) at which Raman scattered photons are collected—which coincides with the focal point of the front lens assembly—is controlled by physically translating the front lens assembly along the optical axis.

One embodiment relates to a Raman spectroscopy system using free space optics to analyze a sample. The system includes an excitation laser source operative to selectively generate an excitation laser beam, the source positioned to deliver the beam along an optical axis and onto a sample. The system also includes a front lens assembly having a fixed focal distance defining a Collection Point (CP), the front lens assembly positioned on the optical axis and selectively moveable along the optical axis, the front lens assembly operative to collect Raman scattered photons from the sample primarily at the CP. The system further includes a detector positioned and operative to detect Raman scattered photons collected from the sample at the CP by the front lens assembly, and a data processor operative to analyze the spectra of Raman scattered photons detected by the detector. Substantially all Raman scattered photons collected from the sample are generated at the CP, and the CP may be positioned along the optical axis by moving the front lens assembly along the optical axis.

Another embodiment relates to a method of performing Raman spectroscopy on a sample. An excitation laser beam is directed onto the sample, the excitation laser beam defining an optical axis. A front lens assembly having a fixed focal distance defining a Collection Point (CP) is positioned on the optical axis, the front lens assembly operative to collect Raman scattered photons from the sample primarily at the CP. The front lens assembly is moved along the optical axis to move the CP along the optical axis upon or within the sample. Raman scattered photons collected from the sample at the CP by the front lens assembly are detected, and the spectra of Raman scattered photons detected by the detector are analyzed.

Yet another embodiment relates to a non-transient computer readable media storing program instructions operative to control a portable Raman spectroscopy system. The Raman spectroscopy system includes an excitation laser source operative to selectively generate an excitation laser beam along an optical axis and onto a sample; a front lens assembly having a fixed focal distance defining a Collection Point (CP), the front lens assembly positioned on the optical axis and selectively moveable along the optical axis, the front lens assembly operative to collect Raman scattered photons from the sample primarily at the CP; and a detector positioned and operative to detect Raman scattered photons collected from the sample at the CP by the front lens assembly. The program instructions are operative to cause a controller to control mechanical means to move the front lens assembly, and hence the CP, along the optical axis to a first position; and to analyze the spectra of Raman scattered photons collected primarily at the CP at the first position.

### BRIEF DESCRIPTION OF THE DRAWINGS

The present invention will now be described more fully hereinafter with reference to the accompanying drawings, in which embodiments of the invention are shown. However, this invention should not be construed as limited to the embodiments set forth herein. Rather, these embodiments are provided so that this disclosure will be thorough and complete, and will fully convey the scope of the invention to those skilled in the art. Like numbers refer to like elements throughout.

FIG. 1 is an optical schematic view of a Raman spectroscopy system having an adaptive front lens.

FIGS. 2A and 2B are graphs of Raman spectra.

FIG. 3 is a flow diagram of a method of positioning a lens in a Raman spectroscopy system.

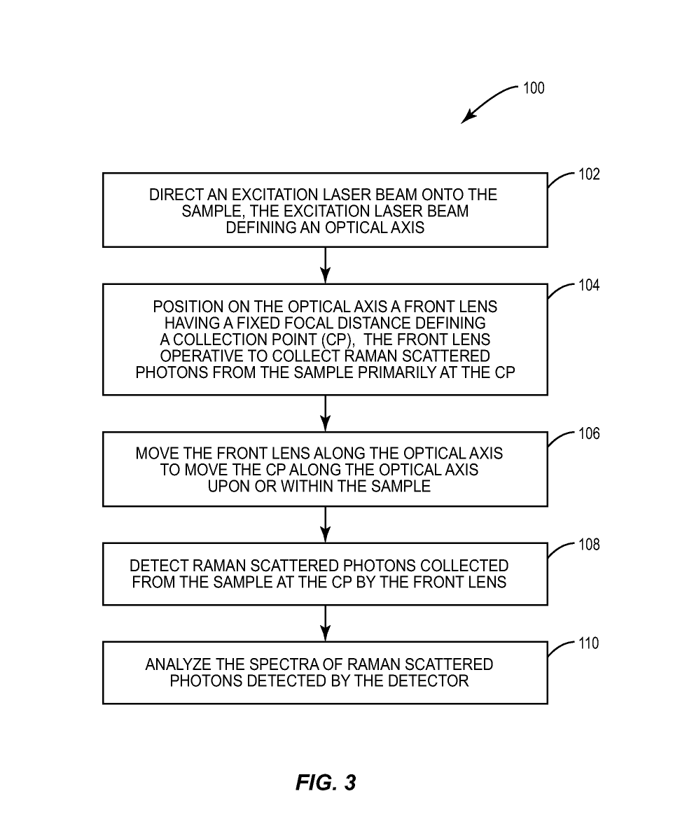

### DETAILED DESCRIPTION

It should be understood at the outset that although illustrative implementations of one or more embodiments of the present disclosure are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

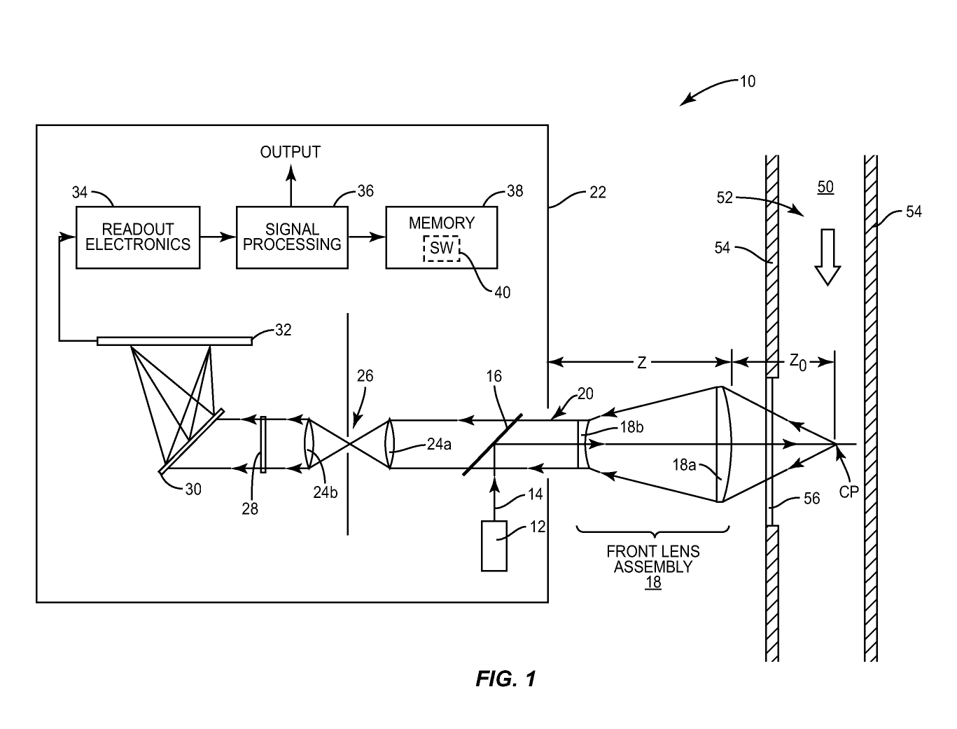

FIG. 1 depicts a sectional, optical schematic view of some essential elements of a Raman spectroscopy system 10 utilizing free space optics, according to one embodiment of the present invention. A spectrometer 22 having a moveable front lens assembly 18 is adapted to perform Raman spectroscopy of a transparent or translucent sample 50, for example a fluid 50 as it travels in a pipe 52 defined by pipe walls 54. A sight glass 56 is affixed to an aperture in the pipe wall 54, to allow remote Raman spectroscopy through the sight glass 56, without touching the fluid 50. Although embodiments of the present invention are described herein with respect to this environment, the present invention is not limited to performing Raman spectroscopy on fluids, or to the particular mechanical arrangement depicted in FIG. 1.

The major optical components of the spectrometer 22 will now be described. A laser source 12 generates an excitation laser beam 14. The excitation beam 14 is reflected by a dichroic mirror 16, and thence defines an optical axis. The direction of the optical axis is referred to herein as the z-direction. The excitation beam 14 passes through a front lens assembly 18. The front lens assembly 18, as well as other optical components, is positioned along the optical axis defined by the excitation laser beam 14. The front lens assembly 18 is attached to the spectrometer 22 by mechanical means, such as a stepper motor driven linear actuator (not shown), that allows the front lens assembly 18 to be selectively moved along the optical axis (i.e., in the z-direction) with respect to the spectrometer 22. That is, the distance denoted z in FIG. 1 between the spectrometer aperture 20 and the front of the front lens assembly 18 is selectively variable.

The collimated excitation laser beam 14 has a small diameter compared to the lens 18. It passes through the center of the lens 18 where the excitation beam 14 is normal to the lens surfaces and experiences little refraction, thus remaining substantially collimated. Additionally, the excitation beam 14 has a very small “dot” of cross-section area, and the lens 18 does little to focus or otherwise optically alter the excitation beam 14.

The front lens assembly 18 has a fixed focus, at a point z₀ in front of the front lens element 18a, in the z-direction, referred to herein as the Collection Point (CP). As one non-limiting example, the front lens assembly 18 may comprise a two-element inverse Galilean Telescope lens system, comprising anti-reflection coated quartz elements. In one embodiment, the front element 18a is plano-convex and of 2.5 cm diameter, and rear element 18b is plano concave of 1 cm diameter. The lens elements 18a, 18b are selected and disposed so that light collected by the front lens element 18a is directed onto the rear lens element 18b, which then directs the collected light as a non-converging (infinite focal length) beam through the dichroic mirror 16 and into an aperture 20 in the spectrometer 22. The CP may, for example, lie 100 mm in front of the lens element 18a. An optical path behind the front lens assembly 18 (to the left as depicted in FIG. 1) is focused to infinity, allowing the front lens assembly 18 to move along the optical axis, in the z-direction, without substantially affecting the optical path of the spectroscopy system 10. In other embodiments, the front lens assembly 18 may comprise more, or fewer, lenses and other optical elements, than the embodiment depicted in FIG. 1.

Focusing lenses 24a and 24b focus the light collected by the front lens assembly 18 to a point, where it passes through a spectrometer aperture slit 26, and back into an optical beam. The spectrometer aperture slit 26 isolates the interior of the spectrometer 22 (in particular, the detector 32) from extraneous photons. In one embodiment, a laser rejection dichroic filter 28 substantially blocks photons at the wavelength of the excitation laser beam 14. This removes most non-Raman scattered photons (e.g., Rayleigh scattered photons), which have the same wavelength as the excitation laser beam 14, from the optical signal, thus enhancing the signal to noise ratio (SNR) of the Raman spectroscopy signal.

A transmission grating 30 then directs the collected, Raman scattered photons to a detector 32. In one embodiment, the transmission grating 30 is a holographic transmission grating comprising a transparent window with periodic optical index variations, which diffract different wavelengths of light from a common input path into different angular output paths. In one embodiment, the holographic transmission grating 30 comprises a layer of transmissive material, such as dichromated gelatin, sealed between two protective glass or quartz plates. The phase of incident light is modulated, as it passes through the optically thick gelatin film, by the periodic stripes of harder and softer gelatin. In another embodiment, the transmission grating 30 comprises a “ruled” reflective grating, in which the depth of a surface relief pattern modulates the phase of the incident light. In all embodiments, the spacing of the periodic structure of the transmission grating 30 determines the spectral dispersion, or angular separation of wavelength components, in the diffracted light. In one embodiment, the detector 32 comprises a charge-coupled device (CCD) array. The detector 32 converts incident photonic energy to electrical signals, which are processed by readout electronics 34.

The spectroscopy data from the readout electronics 34 are analyzed by a signal processor 36, such as an appropriately programmed Digital Signal Processor (DSP) or other microprocessor, also operatively connected to memory 38. Data representing the processed Raman spectra may be stored, output to a display, transmitted across a wired or wireless network, or the like, as known in the art. In addition to analyzing Raman spectra data, the signal processor 36—or another processor (not shown in FIG. 1)—may additionally control the overall operation of the system 10, including initialization, calibration, testing, automated data acquisition procedures, user interface operations, remote communications, and the like. The memory 38 may comprise any non-transient machine-readable media known in the art or that may be developed, including but not limited to magnetic media (e.g., floppy disc, hard disc drive, etc.), optical media (e.g., CD-ROM, DVD-ROM, etc.), solid state media (e.g., SRAM, DRAM, DDRAM, ROM, PROM, EPROM, Flash memory, etc.), or the like. The memory 38 is operative to store program instructions 40 operative to implement the functionality described herein, as well as general purpose control functions for analytical instrumentation, as well known in the art.

The excitation laser beam 14 excites molecules of the sample 50 all along its length (as well as those of the intervening air, the lens elements 18a, 18b, and the sight glass 56). These molecules relax to a different vibration or spin state and generate Raman scattered photons all along the length of the beam 14. However, under normal spectroscopy conditions, substantially the only Raman scattered photons collected, and hence analyzed, by the optics of the system 10 are those generated at the CP. At the CP, Raman scattering may be modeled as a point source optical phenomenon, with isotropic emission. In practice, of course, the CP is not actually a point, but rather a very short range of distance in the z-direction. However, the CP may be conceptualized as a point, and is referred to as such herein, with those of skill in the art appreciating that the size of the CP is limited by achievable optical resolution.

“Normal spectroscopy conditions,” as contemplated by the embodiment of the present invention depicted in FIG. 1, are performing Raman spectroscopy on a transparent or translucent sample 50, such as a fluid. Under these conditions, as stated above, substantially all of the Raman photons collected and analyzed originate at the CP. Under some conditions, such as where the sample 50 or the optical path is highly scattering or lossy—e.g., where the sample 50 is cloudy, a dark liquid, or an opaque state such as a powder—the CP would be hidden by the interposed lossy material. In this case, the Raman emissions would be weak, and would be dominated by poorly-focused surface emission from the sample 50, which is not at the CP. To perform spectroscopy in such cases, the CP would be placed at the outer surface of the sample 50 (e.g., using adaptive optics), and it would not be possible to collect Raman scattered photons from deep within the sample 50. For the purposes of explanation herein, a transparent or translucent sample 50 is assumed, in which substantially all of the Raman scattered photons captured for analysis originate at the CP. When the sample 50 has low optical translucence or is opaque, the CP is assumed to be focused at the surface, and substantially all of the Raman scattered photons captured for analysis will also originate at the CP in this case.

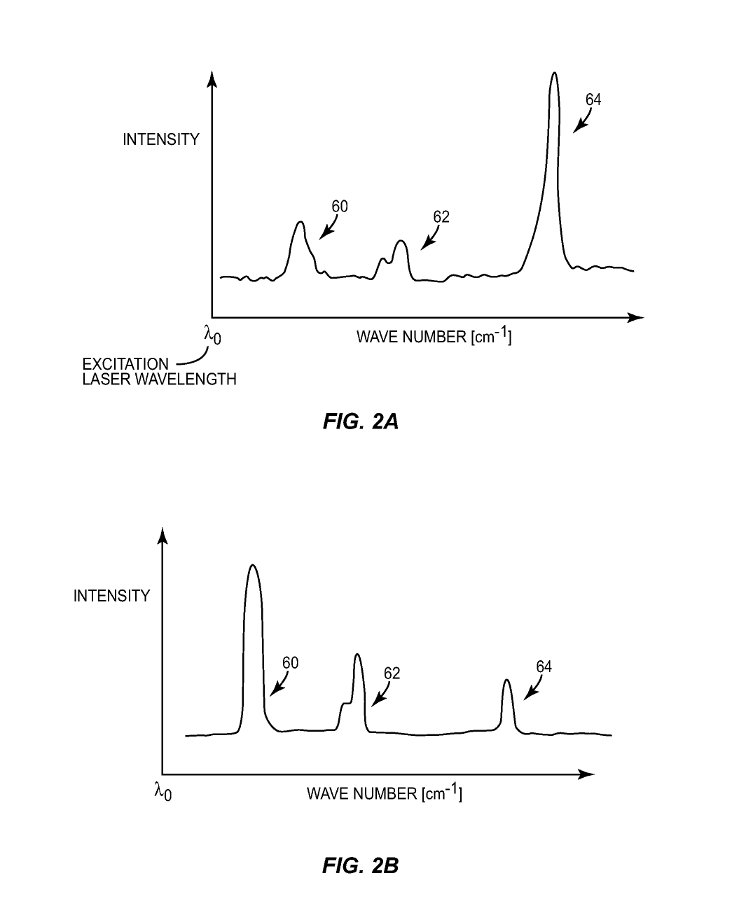

Representative Raman spectra are depicted in FIGS. 2A and 2B, discussed in greater detail below. Raman shifts are typically described as wavenumbers, which have units of inverse length [cm⁻¹]. A wavenumber relates to frequency shift by

$$Δ w = ( \frac{1}{{λ}_{0}} - \frac{1}{{λ}_{1}} )$$

where

w is the wavenumber;

λ₀ is the wavelength of the excitation laser beam 14; and

λ₁ is the wavelength of the Raman scattered photon.

According to embodiments of the present invention, the position of the CP may be varied in the z-direction by moving the front lens assembly 18 forwards (towards the sample 50) or backwards (towards the spectrometer 22). The optical system behind the front lens assembly 18 is focused to infinity; accordingly, the distance denominated as z in FIG. 1 may be varied over a wide range, such as 5 cm in one embodiment, without adversely impacting optical integrity. The focal distance of the CP, denoted z₀ in FIG. 1, is fixed. In this manner, the depth within a transparent or translucent sample 50 at which Raman spectroscopy is performed may be selectively varied.

As one representative example of an advantage of a selectively locatable CP, FIG. 1 depicts a free space optics Raman spectroscopy system 10 analyzing a fluid sample 50 moving through a pipe 52. A transparent sight window 56 is disposed in one wall 54 of the pipe 52. By moving the front lens assembly 18 in the z-direction, the depth of the CP within the sample 50 may be controlled. This may be advantageous for several reasons.

In one embodiment, as depicted in FIG. 1, the sight glass 56 inserted into the pipe wall 54 may leave a space, or void, behind it, which may alter the flow characteristics of the sample fluid 50. For example, an eddy current may form, tending to trap sample fluid 50 immediately behind the sight glass 24. To ensure that Raman spectra is obtained from “fresh” sample material 50, the CP may be positioned well beyond the inner surface of the sight glass 56, in the main flow of sample fluid 50.

Similarly, a flowing sample fluid 50 may comprise a viscous fluid. Viscous fluids may flow in a less turbulent, more laminar or essentially laminar mode than lower viscosity fluids, meaning they tend to “hug” the pipe walls 56, forming an essentially stationary boundary layer. Fluid exchange at the walls of such a pipe, and similarly in any sight glass mount, etc. may be much slower than the center of the flow, and may depend on diffusion, which can be slow. The fluid in such regions thus may not reflect changes in composition of the flowing material promptly. By moving the front lens assembly 18 in the z-direction, the CP may be positioned to obtain Raman spectra from the desired region of the fluid 50.

In one embodiment, Raman spectroscopy may be used to position the CP within the sample fluid 50. The spectroscopy system 10 is positioned, and the position of the front lens assembly 18 adjusted, such that the CP falls outside the sample fluid 50 of interest—for example, outside of the sight glass 56. Data is obtained from the detector 32 and analyzed. The front lens assembly 18 is then moved forward a predetermined distance, and another spectroscopy reading is obtained. The process continues until the optimal CP position is determined. For example, the Raman spectra characteristic of a sample fluid 50 may increase in intensity as the CP moves into through a “dead zone” and into an active region of the sample fluid 50, and consequently decrease in intensity as the CP moves out of the active region. In one embodiment, an optimal CP position is selected based on a quality metric associated with Raman spectral analysis at each of a plurality of CP positions. For example, the optimal CP position may be the CP position that generates the largest signal to noise ratio for particular spectral peaks. As another example, the CP position that generates reasonably large spectral peaks characteristic of the largest number of different sample fluids 50 may be considered optimal. In one embodiment, a plurality of candidate CP positions are determined based on quality metrics associated with the Raman spectra obtained, and a user selects one or more of the candidate CP points at which to perform further Raman spectroscopy. In general, for any given application, the CP may be positioned within the sample fluid 50 to obtain optimal Raman spectroscopy results based on the spectra obtained and the corresponding z values denoting the position of the front lens assembly 18.

In one embodiment, the CP may be located in a predetermined position with a high degree of accuracy by using a marker material on the sight glass 56. A small dot of material having a known, distinct Raman spectral signature, such as Polystyrene or Calcite, may be applied to the front of the sight glass 56 where the excitation laser beam 14 passes through it. This material is referred to herein as a marker material. As described above, Raman spectra are obtained and analyzed as the front lens assembly 18 is moved, changing the position of the CP. The Raman spectra characteristic of a marker material will be obtained when the CP is coincident with the outer surface of the sight glass 56. The corresponding position of the front lens assembly 18 is noted as a reference position. The CP may then be precisely positioned, for example, just inside the sight glass 56, by moving the front lens assembly 18 a known distance from the reference position.

FIG. 2A depicts a representative spectrum when the CP is incident on the marker material. The Raman peaks 60 and 62 are characteristic of the sample fluid 50, and have a low intensity since the CP is not located within the fluid 50. The peak 64 is characteristic of the marker material, and has a high intensity when the CP is coincident with the marker material (i.e., on the front surface of the sight glass 56). FIG. 2B depicts the spectrum when the CP is moved past the sight window 56 some predetermined distance, into the sample fluid 50. The peaks 60 and 62 characteristic of the sample fluid 50 have a high intensity. The peak 64 characteristic of the marker material still appears, as the excitation laser beam 14 passes through the marker material and some Raman scattered photons are emitted in the direction of the spectroscopy system 10. However, the intensity of the peak 64 is low, since the CP is not coincident with the marker material. Of course, the spectra of FIGS. 2A and 2B are only for explanation, and do not necessarily represent any actual Raman spectroscopy results.

The capability to precisely locate the CP at known distances may be useful for analyzing highly dispersive sample fluid 50, which necessitates positioning the CP a minimal depth into the fluid 50. As another example, some fluid 50 may leave deposits, such as through crystallization, on the inner walls 54 of the pipe 52, including the inner surface of the sight glass 56. By locating the CP at the outer surface of the sight glass 56 using the marker material Raman spectral response, then moving the front lens assembly 18 forward a distance corresponding to the known thickness of the sight glass 56, the CP may be positioned at the point of sample fluid 50 surface deposits, with a high degree of precision. In another embodiment, the crystallization of sample fluid 50 at the inner surface of the sight glass 56 may be detected by noting a different Raman spectral response due to phase and density differences from the sample 50.

Embodiments of the present invention present numerous advantages over the prior art. By providing a portable Raman spectrometer 22, and utilizing free space optics, Raman spectroscopy of a sample 50 may be performed remotely, without touching the sample 50 material or exposing it to air. In this manner, Raman spectroscopy may safely be performed on hazardous or sensitive materials 50, such as materials that are highly toxic, pharmacologically potent, infectious, reactive, explosive, radioactive, materials which must be kept sterile or exceptionally clean, and the like, without physical contact with the analyzer, as is required using fiber optic probes and cables. By moving the front lens assembly 18 with respect to the spectrometer 22, the depth of the CP within a sample 50 may be varied, to perform Raman spectroscopy of specific components of the sample 50 (e.g., selected flow zones, surface or boundary phenomena, or the like). It is not possible to selectively collect Raman returns from different z-axis positions using fiber optic cables. By utilizing Raman spectral analysis in a CP-positioning feedback loop, the spectroscopy results may be used to precisely position the CP at an optimal point. By using marker materials, the CP may be precisely positioned at predetermined positions. Neither of these techniques of positioning the CP is possible using fiber optic cables.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A Raman spectroscopy system using free space optics to analyze a sample, comprising:
an excitation laser source operative to selectively generate an excitation laser beam, the source positioned to deliver the beam along an optical axis and onto a sample;
a front lens assembly having a fixed focal distance defining a Collection Point (CP), the front lens assembly positioned on the optical axis and selectively moveable along the optical axis, the front lens assembly operative to collect Raman scattered photons from the sample primarily at the CP;
a detector positioned and operative to detect Raman scattered photons collected from the sample at the CP by the front lens assembly; and
a data processor operative to analyze the spectra of Raman scattered photons detected by the detector;
wherein substantially all Raman scattered photons collected from the sample are generated at the CP, and wherein the CP may be positioned along the optical axis by moving the front lens assembly along the optical axis.

2. The Raman spectroscopy system of claim 1 wherein the front lens assembly is operative to focus an optical path extending in the direction of the detector at infinity, such that selectively moving the front lens assembly along the optical axis, to change the distance between the front lens assembly, and the detector does not significantly alter an optical signal projected along the optical path.

3. The Raman spectroscopy system of claim 1 wherein a laser rejection dichroic filter operative to substantially block photons at the wavelength of the excitation laser beam is interposed in the optical path between the front lens assembly and the detector.

4. The Raman spectroscopy system of claim 1 wherein a transmission grating is interposed in the optical path between the front lens assembly and the detector, the transmission grating being operative to refract the optical signal such that Raman scattered photons of different energies impinge spatially separated areas of the detector.

5. The Raman spectroscopy system of claim 1 wherein the system is portable.

6. A method of performing Raman spectroscopy on a sample, comprising:
directing an excitation laser beam onto the sample, the excitation laser beam defining an optical axis;
positioning on the optical axis a front lens assembly having a fixed focal distance defining a Collection Point (CP), the front lens assembly operative to collect Raman scattered photons from the sample primarily at the CP;
selectively moving the front lens assembly along the optical axis to move the CP along the optical axis upon or within the sample;
detecting Raman scattered photons collected from the sample at the CP by the front lens assembly; and
analyzing the spectra of detected Raman scattered photons.

7. The method of claim 6, wherein the sample is contained in a vessel having at least one area that is optically non-opaque, and wherein selectively moving the front lens assembly along the optical axis to move the CP along the optical axis upon or within the sample comprises moving the front lens assembly such that the CP is positioned within the vessel while the front lens assembly remains outside the vessel.

8. The method of claim 7, wherein the vessel is a pipe and the sample is a viscous fluid, and wherein selectively moving the front lens assembly along the optical axis to move the CP along the optical axis upon or within the sample comprises moving the front lens assembly such that the CP is positioned within a desired flow region of the fluid.

9. The method of claim 6, further comprising repeating the moving, detecting, and analyzing steps so as to selectively position the CP within the sample in response to the quality of the analysis.

10. The method of claim 9, further comprising:
automatically moving the front lens assembly, and detecting and analyzing Raman scattered photons collected at the corresponding CP, a plurality of times to obtain Raman spectroscopy data of the sample from a corresponding plurality of positions;
displaying a quality metric associated with each of the plurality of Raman spectroscopy data; and
accepting user input selecting one of the plurality of positions at which to perform Raman spectral analysis, based on the displayed quality metrics.

11. The method of claim 6, wherein a marker material having a known Raman spectra different from that of the sample is interposed on the optical path between the front lens assembly and the sample, the method further comprising:
determining a reference position for the CP by performing the moving, detecting, and analyzing steps as required to ascertain the greatest concentration of the marker material, and defining the corresponding CP position as a reference position; and
moving the front lens assembly a predetermined distance, to place the CP the predetermined distance beyond the reference position.

12. The method of claim 11, wherein the sample is an optically non-opaque fluid in a pipe having a sight glass on the optical path such that the CP can be positioned within the fluid in the pipe while the front lens assembly is outside the pipe, further comprising:
depositing marker material on the sight glass; and
wherein the reference position is the outer surface of the sight glass.

13. A non-transient computer readable media storing program instructions operative to control a portable Raman spectroscopy system including an excitation laser source operative to selectively generate an excitation laser beam along an optical axis and onto a sample, a front lens assembly having a fixed focal distance defining a Collection Point (CP), the front lens assembly positioned on the optical axis and selectively moveable along the optical axis, the front lens assembly operative to collect Raman scattered photons from the sample primarily at the CP, and a detector positioned and operative to detect Raman scattered photons collected from the sample at the CP by the front lens assembly, the program instructions operative to cause a controller to:
control mechanical means to move the front lens assembly, and hence the CP, along the optical axis to a first position; and
analyze the spectra of Raman scattered photons collected primarily at the CP at the first position.

14. The non-transient computer readable media of claim 13 wherein the program instructions are further operative to cause the controller to:
move the CP along the optical axis to a second position;
analyze the spectra of Raman scattered photons collected primarily at the CP at the second position; and
compare Raman spectral data collected at the first and second positions.

15. The non-transient computer readable media of claim 14 wherein analyzing the spectra of Raman scattered photons includes generating a quality metric associated with the Raman spectral data, and wherein the program instructions are further operative to cause the controller to:
output one or more of the first and second CP positions, and at least the quality metric associated with the Raman spectral data collected at the corresponding position; and
accept user input selecting one of the output positions at which to perform Raman spectral analysis.

16. The non-transient computer readable media of claim 13 wherein a marker material having a known Raman spectra different from that of the sample is interposed on the optical path between the front lens assembly and the sample the wherein the program instructions are further operative to cause the controller to:
iteratively perform the front lens assembly movement and Raman spectral data analysis steps to locate a CP at which the greatest concentration of the marker material is detected;
define the corresponding CP as a reference position;
move the front lens assembly a predetermined distance, to place the CP the predetermined distance beyond the reference position.
